(19) United States
(12) Patent Application Publication
(10) Pub. No.: US 2006/0027420 A1
(43) Pub. Date: Feb. 9, 2006

(54) Semi-active muffler

(76) Inventors: Wolfgang Hahnl, Grimma (DE); Robin Willats, Columbus, IN (US); Jurgen Lesch, Augsburg (DE); Klaus Regenold, Friedberg (DE); Melvyn Caunt, Alsmoos-Petersdorf (DE)

Correspondence Address: BARNES & THORNBURG, 11 SOUTH MERIDIAN, INDIANAPOLIS, IN, 46204, US

(21) Appl. No.: 10/910,662

(22) Filed: Aug. 3, 2004

(51) Int. Cl. F01N 1/00; F01P 1/08; F16K 17/00

(52) U.S. Cl. 181/283; 181/237

(57) ABSTRACT

A semi-active muffler has a casing, an inlet pipe for exhaust gas, at least one outlet pipe for the exhaust gas, a valve element controlling flow of exhaust gas, a spring cooperating with the valve element and biasing the valve element into a first position. Cooling means are provided for reducing the amount of heat transferred from the exhaust gas to the spring.

### FIELD OF THE DISCLOSURE

The present disclosure relates to a semi-active muffler, in particular for the exhaust gas system of a vehicle.

### BACKGROUND OF THE DISCLOSURE

Mufflers are used for attenuation of the noise resulting from pressure variations and oscillations in the exhaust gas of an internal combustion engine. Mufflers generally use attenuation chambers and/or reflection chambers through which the exhaust gas is guided. A problem inherent with mufflers is that the efficiency of the muffler depends from the particular parameters of operation. Accordingly, each muffler has a certain point of operation at which the muffler is most efficient. Outside this point of operation, the efficiency is below its maximum.

In an attempt to achieve a larger region of operation at which the muffler works with maximum efficiency, semi-active mufflers were developed which use a valve for switching the muffler between two different operating conditions. In particular, the valve is used for changing the flow path of the exhaust gas in the interior of the muffler. Examples of semi-active mufflers can be found in German Patent Publication 199 47 938 and German Patent Specification 199 35 711. The disclosure of these documents is incorporated herein by reference.

Briefly summarized, a semi-active muffler comprises a valve element which is actuated by the exhaust gas flowing through the muffler. Typically, an actuator is coupled to the valve element and is arranged in the flow path of the exhaust gas entering the muffler. A spring is provided which biases the valve element into a first position. This results in the exhaust gas taking a first flow path through the muffler. As soon as the amount of exhaust gas flowing through the muffler reaches a certain volume, the valve element is switched by the actuator from the first position into a second position. The exhaust gas then flows through the muffler in a second flow path. The first flow path is specifically adapted in view of a good performance of the muffler when operated with a volume of exhaust gas below a predefined level, and the second flow path is adapted in view of good performance under conditions in which the amount of exhaust gas flowing through the muffler exceeds the predefined level.

Even though the spring used for biasing the valve element into the first position is made from a material particularly adapted to high operating temperatures, there is the problem that the spring tends to relax when being subjected to high temperatures for a long period. Specifically, it is to be expected that the spring will almost entirely relax when being subjected to temperatures of more than 700° C. for a period of more than 24 hours.

Accordingly, there is a need for a muffler which can be operated under high loads for a long period of time without there being a risk that relaxation of the spring occurs.

### SUMMARY OF THE DISCLOSURE

The present disclosure provides a semi-active muffler which has a casing, an inlet pipe for exhaust gas and at least one outlet pipe for the exhaust gas. A valve element is provided which controls flow of the exhaust gas. A spring cooperates with the valve element and biases the valve element into a first position. Cooling means are provided for reducing the amount of heat transferred from the exhaust gas to the spring. The cooling means ensures that the operating temperature of the spring is reduced and remains at a reduced level. This prevents the spring from relaxing or at least significantly delays relaxation of the spring.

According to a preferred embodiment, the cooling means acts so as to decrease the temperature of the exhaust gas to which the spring is subjected. One option is to reduce the overall temperature of the exhaust gas entering the muffler. To this end, a cooling fluid can be added to the exhaust gas, for example ambient air or water. Alternatively, the cooling means can be formed by cooling ribs provided on the inlet pipe for reducing the temperature of the exhaust gas. In an alternative embodiment, the cooling means can be formed so as to reduce the temperature of the exhaust gas only in the direct vicinity of the spring. To this end, a cooling liquid can be introduced into the muffler in the vicinity of the spring. Alternatively, a heat exchanger in the form of a cooling rib can be used which extends to a point in the vicinity of the spring.

Rather than reducing the temperature of the exhaust gas to which the spring is subjected, the cooling means can be formed so as to prevent the hot exhaust gas from directly contacting the spring. To this end, the cooling means can be formed in the form of an isolating body circumscribing the spring, or in the form of a shield which diverts the hot exhaust gas away from the spring.

### BRIEF DESCRIPTION OF THE DRAWINGS

The present disclosure will now be described with reference to preferred embodiments which are shown in the enclosed drawings. In the drawings,

FIG. 1 shows a schematic view of a semi-active muffler according to a first principle,

FIG. 2 shows an enlarged view of the valve element and the spring used in the muffler of FIG. 1,

FIG. 3 shows a schematic view of a semi-active muffler according to a second principle,

FIG. 4 shows a first embodiment of the cooling means;

FIG. 5 shows a cooling means according to an embodiment which is an alternative to the cooling means shown in FIG. 4,

FIG. 6 shows the cooling means in a further alternative;

FIG. 7 shows cooling means according to a second embodiment of the invention,

FIG. 8 shows cooling means according to a third embodiment of the invention,

FIG. 9 shows cooling means according to a fourth embodiment of the invention,

FIG. 10 shows cooling means according to a fifth embodiment of the invention,

FIG. 11 shows a section in plane XI of FIG. 10,

FIG. 12 shows cooling means according to a sixth embodiment of the invention, and

FIG. 13 shows cooling means according to a seventh embodiment of the invention.

### DETAILED DESCRIPTION OF THE DRAWINGS

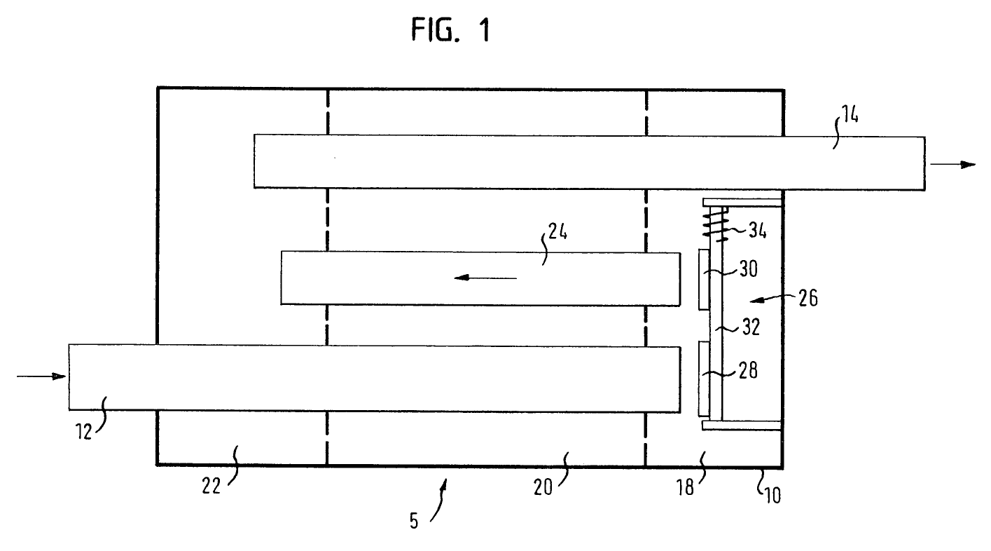

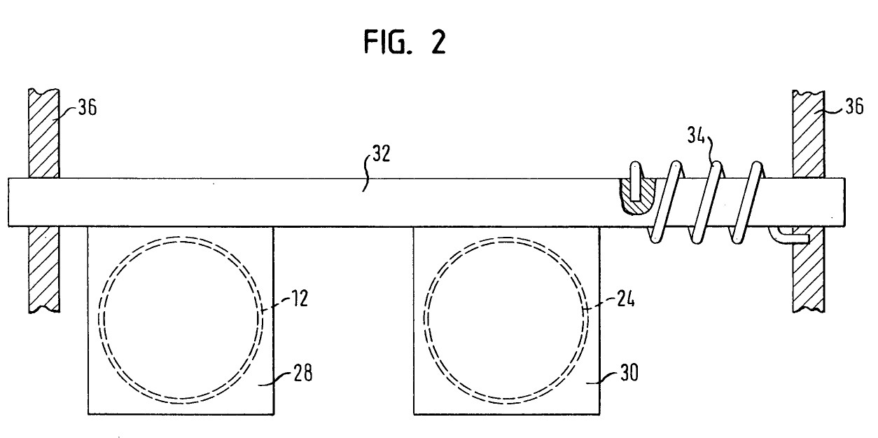

FIG. 1 shows a semi-active muffler having a casing 10, an inlet pipe 12 and an outlet pipe 14. The inlet pipe is intended to guide exhaust gas of an internal combustion engine into casing 10 of the muffler. Outlet pipe 14 is intended to discharge the exhaust gas from casing 10. In the interior of casing 10, three chambers 18, 20, 22 are formed. These chambers are used for absorbing, dampening or otherwise reducing pressure variations in the exhaust gas. An overflow pipe 24 is provided which provides a direct fluid communication from chamber 18 to chamber 22. Associated with the end of inlet pipe 12 and one of the ends of overflow pipe 24 is a valve assembly which is designated with reference numeral 26. Valve assembly 26 consists of a first valve element 28 associated with inlet pipe 12, a second valve element 30 associated with overflow pipe 24, a valve spindle 32 and a spring 34 (please see FIG. 2). Valve spindle 32 is supported in two holding plates 36. Spring 34 biases first and second valve elements 28, 30 into a position in which they are adjacent the outlet of inlet pipe 12 and the inlet of overflow pipe 24, respectively. Depending on the volume of exhaust gas flowing through inlet pipe 12 and acting on first valve element 28, valve spindle 32 together with first and second valve elements 28, 30 pivots so as to move first and second valve elements 28, 30 further away from inlet pipe 12 and overflow pipe 24, respectively. This results in a reduction of the resistance to flow of the exhaust gas from chamber 18 through overflow pipe 24 directly towards chamber 22.

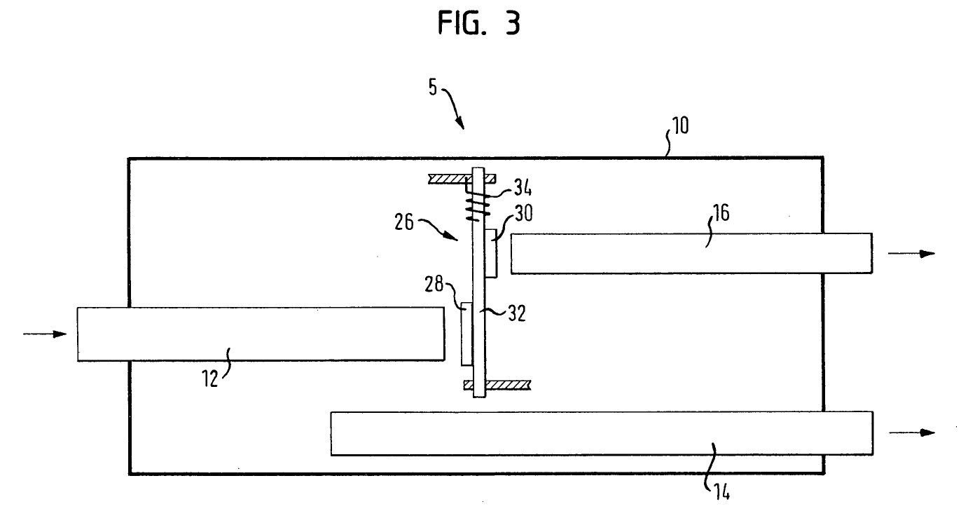

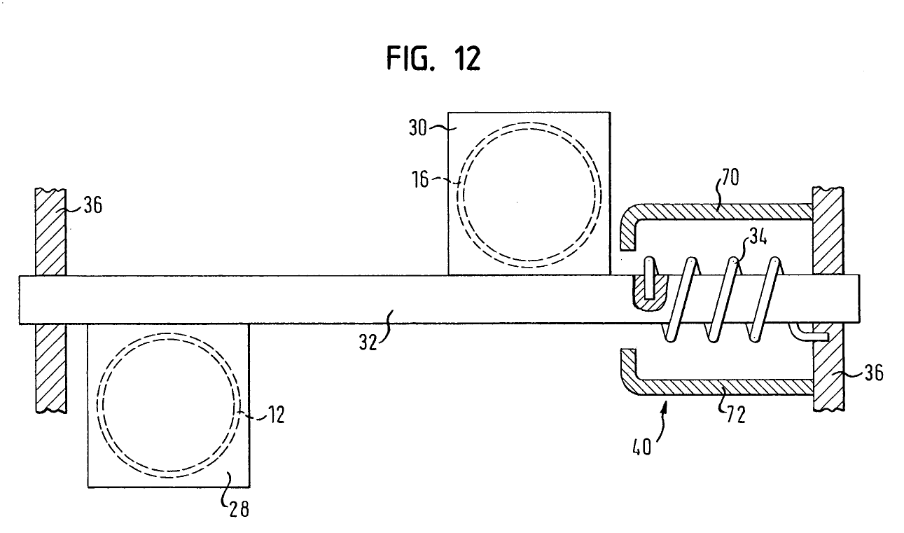

FIG. 3 shows an alternative design of the semi-active muffler. The difference between the first and the second design is that in addition to outlet pipe 14, a second outlet pipe 16 is provided. Second valve element 30 of valve assembly 26 is associated with the second outlet pipe 16. As compared to the design shown in FIGS. 1 and 2, the second valve element 30 is arranged on a side which, with respect to a center line of valve spindle 32, is opposite first valve element 28 (please see FIG. 12). Here again, spring 34 biases valve spindle 32 together with first and second valve elements 28, 30 into a position in which both valve elements are close to the respective pipe. The action of the spring can be overcome by a sufficient amount of exhaust gas acting on first valve element 28, resulting in spindle 32 being pivoted together with second valve element 30.

The particulars of the construction of the mufflers shown in FIGS. 1 to 3 are well-known to a man of ordinary skill in the art so that no additional comments thereon are required.

As spring 34 is provided in the interior of casing 10, there is a risk that the spring is objected to temperatures which, over a long period of time, lead to a relaxation of the spring even though the spring is formed from Inconel. If such relaxation would occur, the elasticity of the spring and accordingly the biasing effect of the spring would be lost. In order to produce the amount of heat transferred from the exhaust gas to spring 34, cooling means are provided.

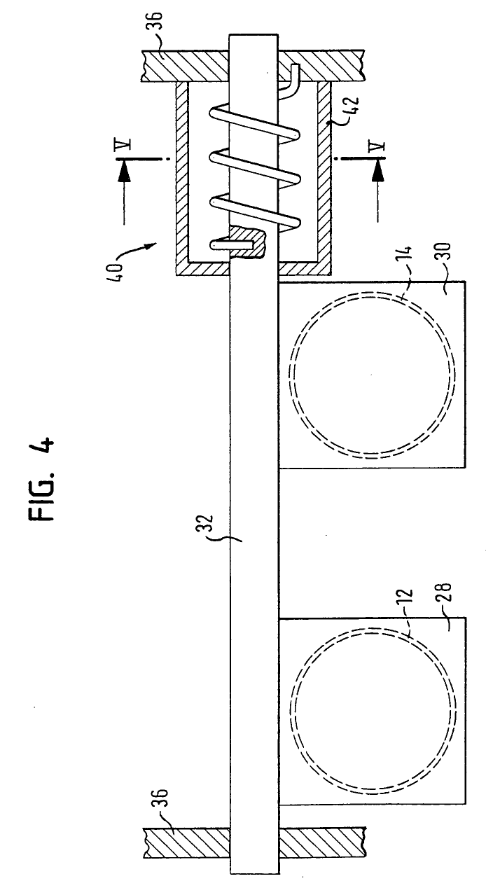

FIG. 4 shows cooling means 40 according to a first embodiment. Cooling means 40 are formed as an isolating body 42 which circumscribes spring 34. Accordingly, it is prevented that the hot exhaust gas in the interior of casing 10 directly contacts spring 34 and transfers heat to the spring.

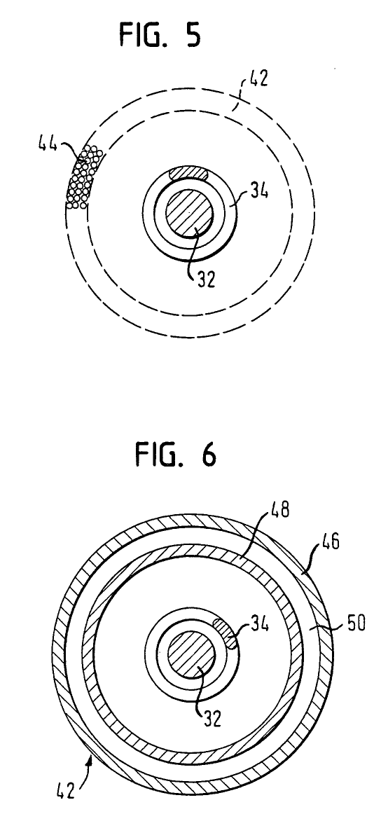

Isolating body 42 can be formed from sheet metal, as is shown in FIG. 4. According to an alternative construction shown in FIG. 5, isolating body 42 can be formed from a plurality of small hollow metallic spheres 44 which are sintered together. The details of such material are well known to those skilled in the art. Also, isolating body 42 can be formed from a ceramic material.

According to an alternative construction shown in FIG. 6, isolating body 42 is formed from two concentric shells 46, 48 with a space 50 filled with air formed between the shells. This increases the resistance to heat transfer from the outside of isolating body 42 towards spring 34.

It is obvious that isolating body 42 delays the transfer of heat from the exhaust gas towards spring 34 rather than completely preventing such transfer. However, this delay is sufficient to prevent relaxation of spring 34. In fact, the temperature of the exhaust gas entering muffler 5 reaches temperatures critical for relaxation of spring 34 only if the internal combustion engine is operated under full load. Only under these conditions, the exhaust gas in muffler 5 reaches temperatures in the region of 700° C. or more. As soon as the engine is operated below a full load condition, the temperature of the exhaust gas in muffler 5 falls to values which are uncritical regarding the issue of relaxation of spring 34. In practice, the engine of a motor vehicle is typically operated under full load conditions for a short period of time only. The task of the isolating body is to prevent that spring 34 is exposed to temperatures of 700° C. or more during those typically short time periods in which the combustion engine works under full load.

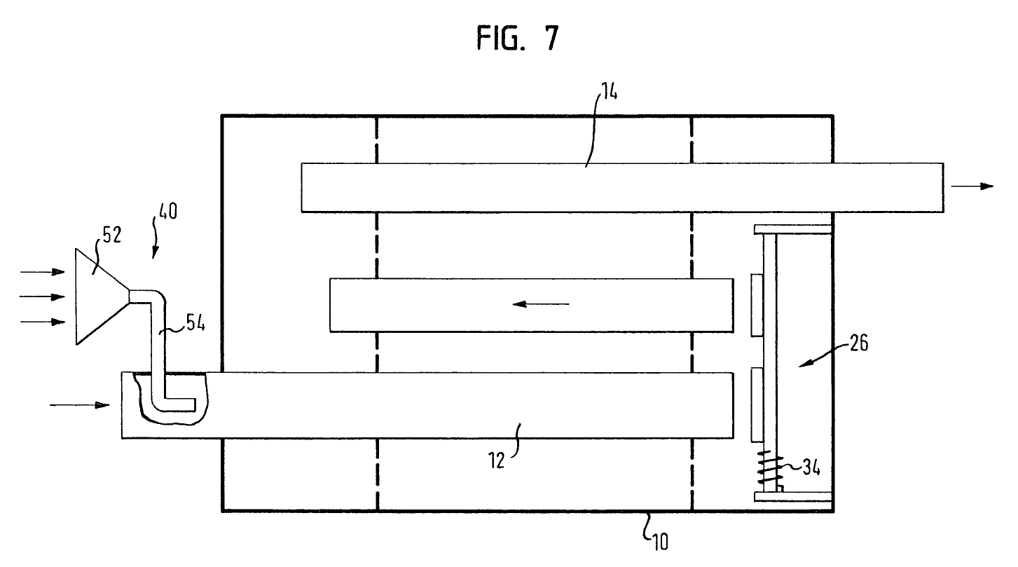

FIG. 7 shows a second embodiment of cooling means 40. Here, cooling means 40 are formed as a system for admitting a cooling fluid to the exhaust gas in inlet pipe 12. The admission system uses a funnel 52 through which ambient air is collected. Funnel 52 is connected to a tube 54 which ends inside inlet pipe 12. The ambient air entering through cooling means 40 reduces the overall temperature of the exhaust gas. Accordingly, less heat is transferred from the exhaust gas to spring 34 arranged inside casing 10.

It is obvious that instead of funnel 52, other means such as a fan could be used for admitting ambient air into exhaust pipe 12.

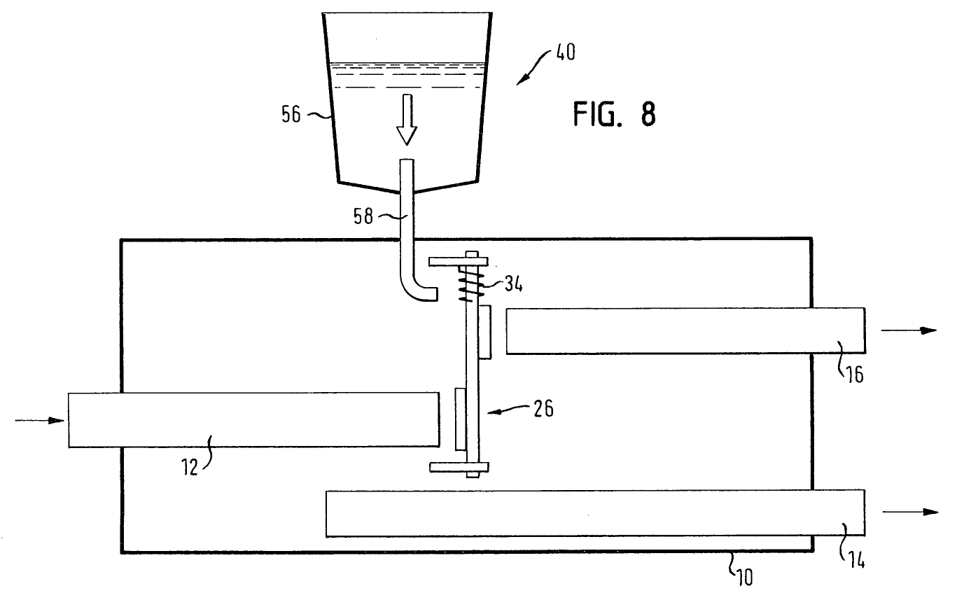

FIG. 8 shows a third embodiment of cooling means 40. Here, cooling means 40 are formed as a system for admitting a cooling liquid into the interior of casing 10, in particular to a point in the vicinity of spring 34. The cooling liquid, preferably water, serves for directly cooling the exhaust gas in the vicinity of spring 34. A tank 56 is provided which is connected to a feeding tube 58. Feeding tube 58 ends at a point in the vicinity of spring 34.

According to an alternative design, the cooling liquid could be introduced into inlet pipe 12 for reducing the temperature of the exhaust gas. Also, ambient air could be introduced into the interior of casing 10 at a point in the vicinity of spring 34.

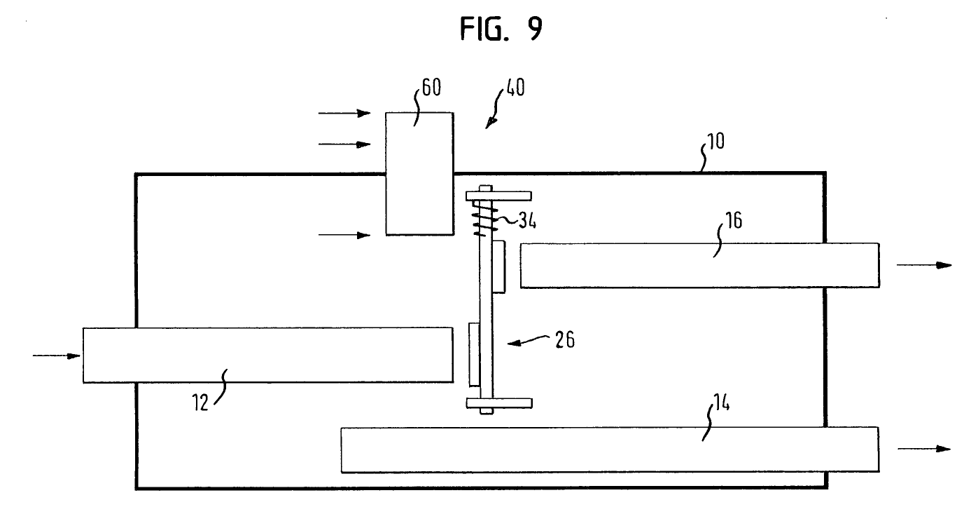

FIG. 9 shows a fourth embodiment of the invention. Here, cooling means 40 are formed as a heat exchanger which acts so as to reduce the temperature of the exhaust gas in the vicinity of spring 34. The heat exchanger is formed as a cooling rib 60 which extends from the outside of casing 10 to a point in the vicinity of spring 34. As the outside end of cooling rib 60 is cooled by ambient air, the exhaust gas flowing over the inside end of cooling rib 60 is cooled. Preferably, the inside end of cooling rib 60 is arranged upstream of spring 34. Further, the plane of cooling rib 60 is preferably oriented in parallel with the flow direction both of the ambient air outside casing 10 and of the exhaust gas inside the casing.

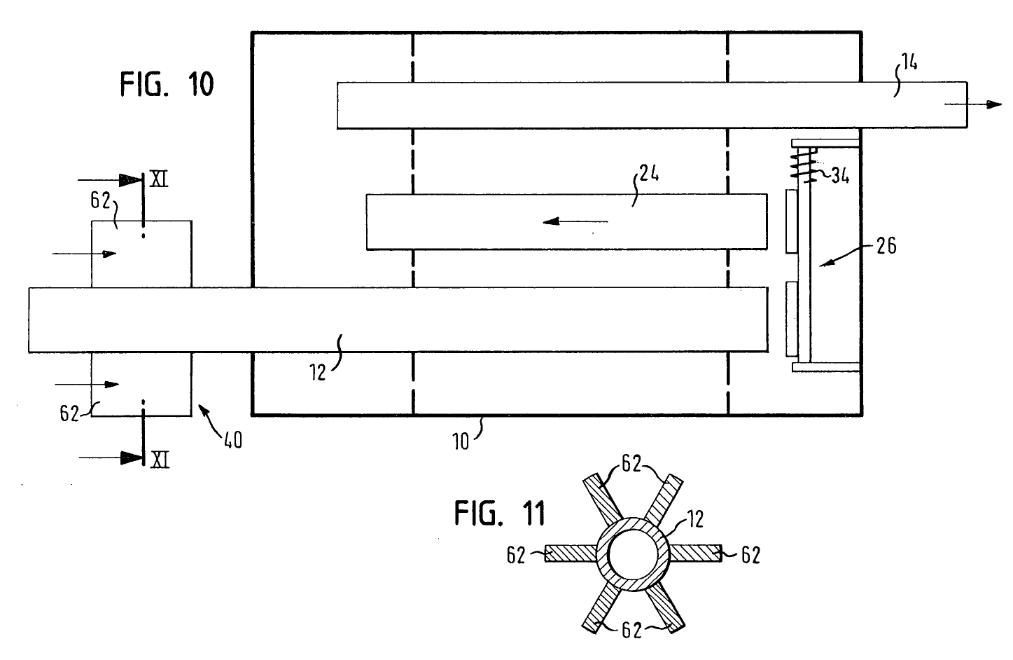

FIG. 10 shows a fifth embodiment of the invention. Here again, a heat exchanger is used. The heat exchanger consists of a plurality of cooling ribs 62 which are attached to inlet pipe 12 outside casing 10 (please see FIG. 11). Cooling ribs 62 increase the amount of heat transferred from the exhaust gas flowing in the interior of inlet pipe 12 to the ambient air. Accordingly, the overall temperature of the exhaust gas entering muffler 5 is reduced. This results in less heat being transferred to spring 34.

FIG. 12 shows a sixth embodiment of cooling means 40. Here, cooling means 40 are formed as two shields 70, 72 which are arranged upstream and downstream of spring 34 and which act so as to protect spring 34 from being directly exposed to the exhaust gas flowing in the interior of casing 10.

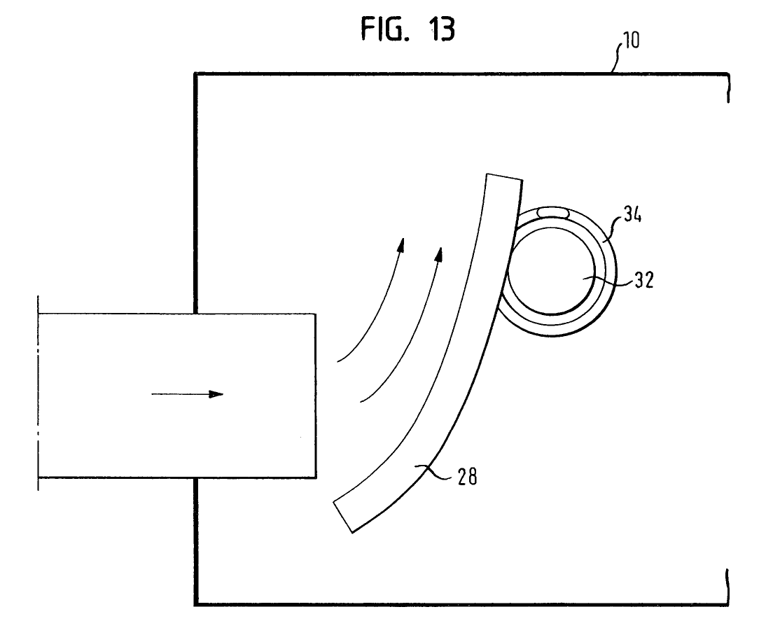

FIG. 13 shows a seventh embodiment of cooling means 40. Here, cooling means 40 is formed directly from first valve element 28 which acts as an actuator for actuating the second valve element. Valve element 28 is formed so as to guide the exhaust gas entering casing 10 away from spring 34. For this purpose, valve element 28 is formed in the manner of a curved blade.

1. Semi-active muffler having a casing, an inlet pipe for exhaust gas, at least one outlet pipe for said exhaust gas, a valve element controlling flow of exhaust gas, a spring cooperating with said valve element and biasing said valve element into a first position, and cooling means for reducing the amount of heat transferred from said exhaust gas to said spring.

2. The muffler of claim 1 wherein said cooling means is an isolating body circumscribing said spring.

3. The muffler of claim 2 wherein said isolating body is made from a ceramic material.

4. The muffler of claim 2 wherein said isolating body is made from a sintered body consisting of hollow metal spheres.

5. The muffler of claim 2 wherein said isolating body consists of two shells separated by a space filled with air.

6. The muffler of claim 1 wherein said cooling means is an admission system for admitting a cooling fluid.

7. The muffler of claim 6 wherein said admission system has an admission opening which is arranged in said inlet pipe upstream of said muffler for admitting said cooling fluid to said exhaust gas prior to entering said muffler.

8. The muffler of claim 6 wherein said admission system has an admission opening which is arranged within said muffler for introducing said cooling fluid in a vicinity of said spring.

9. The muffler of claim 6 wherein said cooling fluid is ambient air.

10. The muffler of claim 6 wherein said cooling fluid is a liquid.

11. The muffler of claim 10 wherein said cooling fluid is water.

12. The muffler of claim 1 wherein said cooling means is a heat exchanger arranged so as to reduce the temperature of said exhaust gas.

13. The muffler of claim 12 wherein said heat exchanger comprises at least one rib extending from a point in a vicinity of said spring to a point outside said muffler so as to reduce the temperature of said exhaust gas in a vicinity of said spring.

14. The muffler of claim 13 wherein said rib has a longitudinal axis which is parallel to a main flow direction of said exhaust gas in said muffler.

15. The muffler of claim 12 wherein said heat exchanger is at least one cooling rib on an outside of said inlet pipe.

16. The muffler of claim 1 wherein said cooling means is a shield arranged inside said muffler for preventing said spring from being directly exposed to said exhaust gas.

17. The muffler of claim 16 wherein said shield is arranged upstream of said spring.

18. The muffler of claim 16 wherein said shield is arranged downstream of said spring.

19. The muffler of claim 16 wherein an actuator is provided for actuating said valve element, said actuator being formed so as to direct said exhaust gas away from said spring.

20. The muffler of claim 1 wherein said spring consists of Inconel.
